(19) United States
(12) Patent Application Publication
(10) Pub. No.: US 2008/0289520 A1
(43) Pub. Date: Nov. 27, 2008

(54) PRINTING ROLLER APPARATUS AND METHOD

(76) Inventor: Aldo PERRONE, Brampton (CA)

Correspondence Address: LANG MICHENER LLP, Brookfield Place, SUITE 2500, 181 BAY STREET, TORONTO, ON, M5J 2T7, CA

(21) Appl. No.: 12/124,443

(22) Filed: May 21, 2008

Related U.S. Application Data
(60) Provisional application No. 60/939,195, filed on May 21, 2007.
(60) Provisional application No. 60/939,583, filed on May 22, 2007.

(51) Int. Cl. B41F 9/00

(52) U.S. Cl. 101/153

(57) ABSTRACT

A printing roller apparatus and method are for use with ink and a gel carried on an operatively rotating casting drum. The apparatus and method include a print roller and a drive member. The print roller has an exterior print surface rollably engaging the gel. The drive member directly engages the casting drum and operatively rotates the print roller, such that the print surface moves coincident with the gel carried on the operatively rotating casting drum. An even distribution of the ink is transferred from the print surface to the gel, so as to clearly print at least one print indicium thereon.

### FIELD OF THE INVENTION

The present invention relates to the field of softgel capsules having printed matter thereon and to a method and apparatus for manufacturing same.

### BACKGROUND OF THE INVENTION

In the prior art, paintballs and other softgel capsules with printed matter thereon may have been somewhat rarely manufactured and/or difficult and/or costly to manufacture. As such, in the prior art, it may have been rare and/or difficult and/or expensive for paintball or other capsule manufacturers to provide printed paintball and other capsules. Imparting the correct speed of rotation to, and/or difficulties associated with correctly and/or efficiently driving, the print roller may have been one of the problems previously associated with providing printed matter on softgel capsules.

Previously, there may have been a number of generally ineffective methods and/or apparatuses that persons (having ordinary skill in the art) may have tried to use to drive the print roller and/or to print onto softgel capsules. In the prior art, for example, persons having ordinary skill in the art may have attempted to drive the print roller by means of the softgel web's elastic tackiness while it was still on the casting drum. It may have been generally believed (though it is not essential to the present invention) that rudimentary devices of this sort may have caused casting drum/web slippage—and/or micro- and/or large-scale tears in the softgel web—such that the web may possibly have been unusable and/or of reduced efficacy for its intended purpose. Additionally, prior art devices may have been subject to unacceptable lag time between commencement of casting drum rotation and the resultant print roller rotation. Other problems that associated with prior art print roller systems may have included, among other things, other difficulties, excessive costs, and/or inefficiencies associated with their use, as well as differential speeds of casting drum and print roller rotation.

What is needed, therefore, is a way by which a paintball manufacturer might make more economic use and/or common provision of printed matter on paintball capsules.

### SUMMARY OF THE INVENTION

In accordance with the present invention there is disclosed a printing roller apparatus, for use with a casting drum, which is suitable to print matter onto a gel on the casting drum. According to the invention, the printing roller apparatus comprises and/or is for use with one or more of the following parts: a gel (e.g., gelatin) carried on a casting drum having a center of rotation, a printing roller provided with a pressure adjusting knob and a rubber drive ring (and/or alternately a drive belt, chain and/or gears), an ink coating on an ink roller, ink inside an ink tray, a scraper/spreader roller, and a secondary scraper.

According to one aspect of the invention, as the casting drum and gel move past the printing roller, pressure may preferably, but need not necessarily, be applied on the rubber drive ring by means of adjusting the pressure adjusting knob—preferably, but not necessarily, so as to cause contact with the casting drum.

According to one aspect of the invention, this contact (and/or the force of static friction) between the casting drum and the rubber drive ring on the printing roller may preferably, but need not necessarily, cause the casting drum to drive the printing roller which, in turn, may preferably drive the rest of the assembly (see FIG. 5).

According to one aspect of an alternate embodiment of the invention, the assembly may alternately be driven by means of a drive belt, chain and/or gears. This alternate drive method may, but need not necessarily, pick-up the rotation of the casting drum—preferably (but not necessarily), from its center of rotation, and preferably (but not necessarily), at a 1:1 ratio (see FIG. 6).

According to one aspect of the alternate embodiment of the invention described above, an arrangement of this general sort may result in the same speed of rotation as direct drive method(s).

By this point, however, we may not yet have described how printing onto the ribbon may occur.

According to one aspect of the invention, in order to print, further pressure must preferably, but need not necessarily, be applied to the rubber drive ring (as it may preferably, but need not necessarily, be raised above the lettering on the printing roller). This adjustment may preferably, but need not necessarily, allow for fine tuning of the printing quality and/or the ink transfer to the gelatin.

According to one aspect of the invention, as the printing roller rotates, it may preferably, but need not necessarily, pick up ink by means of contact from the ink roller, and it may preferably, but need not necessarily, transfer the ink to the gelatin.

According to one aspect of the invention, as the ink roller rotates, it may preferably, but need not necessarily, pick up ink from the ink tray that it is (preferably, but not necessarily, at least partially) submerged in.

According to one aspect of the invention, when the ink roller rotates towards the printing roller, it may preferably, but need not necessarily, pass the scraper/spreader roller and the secondary scraper.

According to one aspect of the invention, the scraper/spreader roller may preferably, but need not necessarily, remove excess ink from the ink roller, and it may preferably, but need not necessarily, help to ensure and/or to facilitate a substantially even distribution of ink over the surface of the ink roller.

According to one aspect of the invention, the secondary scraper may preferably, but need not necessarily, help to prevent and/or to reduce the chance of excess ink overflow.

According to one aspect of the invention, once the ink roller passes the scraper/spreader roller, the uniform ink coating on the ink roller may preferably, but need not necessarily, be then transferred to the printing roller.

In accordance with another embodiment of the present invention there is disclosed another printing roller apparatus, for use with a casting drum, which is suitable to print matter onto a gel on the casting drum. According to the invention, the printing roller apparatus comprises and/or is for use with one or more of the following parts: a gel ribbon carried on a casting drum having a center of rotation, a printing roller provided with print indicia (e.g., lettering), and a rubber drive ring together with an adjusting knob—and/or (A) a drive belt/chain, together with (i) a set of pulleys, and/or (ii) a set of sprockets and chains, and/or (B) a drive gear, including (i) a large casting drum gear, and/or (ii) a printing roller gear. The printing roller apparatus may additionally comprise and/or be for use with one or more of the following parts: one or more suspension springs, a transfer roller, an ink roller, and an ink well.

According to one aspect of the invention, as the casting drum and gel move past the printing roller, pressure may preferably, but need not necessarily, be applied on the rubber drive ring (see FIG. 11A) by means of tightening the adjusting knob—preferably, but not necessarily, so as to cause contact with the casting drum.

According to one aspect of the invention, this contact (and/or the force of static friction) between the casting drum and the rubber drive ring may preferably, but need not necessarily, cause the casting drum to drive the printing roller which, in turn, may preferably drive the rest of the assembly (see FIG. 7).

According to one aspect of another alternate embodiment of the invention, the assembly may alternately be driven by means of a drive belt or chain (see FIGS. 14, 14A and 15). This alternate drive method may, but need not necessarily, pick-up the rotation of the casting drum—preferably (but not necessarily), from its center of rotation, using a set of pulleys or a set of sprockets and chains (see FIGS. 14, 14A and 15).

According to one aspect of yet another alternate embodiment of the invention, the assembly may alternately be driven by means of a drive gear. This alternate drive method may, but need not necessarily, pick-up the rotation of the casting drum—preferably (but not necessarily), from its center of rotation, by affixing a large gear to the drive shaft of the casting drum and having this gear connect with the printing roller gear (see FIGS. 12, 12A and 13).

According to one aspect of either of the two alternate embodiments of the invention described immediately above, an arrangement of this general sort may result in the same speed of rotation as direct drive method(s).

According to one aspect of the invention, printing onto the ribbon may occur by means of further pressure which must preferably, but need not necessarily, be applied to the rubber drive ring—preferably (but not necessarily), so as to allow it to collapse and so as to allow the printing roller to make contact with the gelatin ribbon (as the rubber drive ring may preferably, but need not necessarily, be raised above the lettering on the printing roller).

According to one aspect of the invention, the suspension springs (see FIG. 8) may preferably, but need not necessarily, allow for variations in gelatin ribbon thickness, preferably (but not necessarily) without constant manual adjustment. Accordingly, the suspension springs may preferably (but need not necessarily) allow for fine tuning of the printing quality and/or the ink transfer to the gelatin—preferably (but not necessarily) without having to constantly monitor the printer.

According to one aspect of the invention, as the printing roller rotates, it may preferably, but need not necessarily, pick up ink by direct contact with the transfer roller (see FIG. 9), and the printing roller may preferably, but need not necessarily, transfer the ink to the gelatin.

According to one aspect of the invention, the transfer roller may preferably, but need not necessarily, allow for a small amount of ink to be picked up from the ink roller. According to one aspect of the invention, this feature of the transfer roller may preferably, but need not necessarily, help to ensure that the printing roller will not (and/or it may help to decrease the risk that the printing roller will): (A) become saturated with ink, and/or (B) produce a faulty image or print.

According to one aspect of the invention, as the transfer roller rotates, it may preferably, but need not necessarily, collect ink from the ink roller also by means of direct contact (see FIG. 9). According to one aspect of the invention, the suspension springs (see FIG. 8) may preferably, but need not necessarily, help to ensure and/or to increase the likelihood that constant contact is maintained between the rollers—preferably (but not necessarily) so as to create an even coverage of ink.

According to one aspect of the invention, as the ink roller rotates, it may preferably, but need not necessarily, collect ink from the ink well that it is (preferably, but not necessarily) provided in the bottom of the housing. According to one aspect of the invention, the ink roller may preferably, but need not necessarily, be partially submerged (see FIG. 9) in the ink—preferably, but not necessarily, so as to allow for substantially constant replenishment of ink on the ink roller.

According to the invention, there is also disclosed a printing roller apparatus. The apparatus is for use with ink and a gel carried on an operatively rotating casting drum. The apparatus includes a print roller and a drive member. The print roller has an exterior print surface that operatively and rollably engages the gel. The drive member directly engages the casting drum and operatively rotates the print roller, such that the print surface moves coincident with the gel carried on the operatively rotating casting drum. A substantially even distribution of the ink is transferred from the print surface to the gel, so as to clearly print at least one print indicium thereon.

According to the invention, there is also disclosed a printing method. The method is for use with ink and a gel carried on an operatively rotating casting drum. The method includes a print roller step and a drive step. In the print roller step, a print surface operatively and rollably engages the gel. In the drive step, a drive member directly engages the casting drum and operatively rotates the print roller, such that the print surface moves coincident with the gel carried on the operatively rotating casting drum. According to the method, a substantially even distribution of the ink is transferred from the print surface to the gel, so as to clearly print at least one print indicium thereon.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the printing roller apparatus and method according to the present invention, as to its structure, organization, use and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a top plan view of view of a first printing roller apparatus according to the present invention;

FIG. 2 is a top plan view of the apparatus of FIG. 1, shown in a first partially disassembled configuration, with a mounting housing thereof removed;

FIG. 3 is a side elevational view of the apparatus of FIG. 1;

FIG. 4 is a side elevational “wireframe” view of the apparatus of FIG. 2;

FIG. 5 is a side elevational view of the apparatus of FIG. 2, shown in a second partially disassembled configuration, with a roller plate thereof removed, and shown in use with a casting drum;

FIG. 6 is a view similar to FIG. 5, showing a second printing roller apparatus according to an alternate embodiment of the present invention;

FIG. 7 is a side elevational view of a third printing roller apparatus according to another alternate embodiment of the present invention;

FIG. 8 is a side elevational view of the apparatus of FIG. 7, shown in a first partially disassembled configuration, with printing, transfer and ink/dye roller gears thereof removed;

FIG. 9 is a side elevational view of the apparatus of FIG. 8, shown in partial section;

FIG. 10 is a side elevational view of the apparatus of FIG. 7, shown in use with a casting drum and an oil bank;

FIG. 10A is an enlarged view of encircled area 10A in FIG. 10;

FIG. 11 is a top plan view of portions of the apparatus and the casting drum of FIG. 10;

FIG. 11A is an enlarged view of encircled area 11A in FIG. 11;

FIG. 12 is a view similar to FIG. 10, showing a fourth printing roller apparatus according to a further alternate embodiment of the present invention;

FIG. 12A is an enlarged view of encircled area 12A in FIG. 12;

FIG. 13A is a top plan view of portions of the apparatus and the casting drum of FIG. 12;

FIG. 13A is a view similar to FIG. 13A, showing a fifth printing roller apparatus according to a still further alternate embodiment of the present invention;

FIG. 13C is an enlarged view of encircled area 13C in FIG. 13B;

FIG. 14 is a view similar to FIG. 10, showing a sixth printing roller apparatus according to yet another alternate embodiment of the present invention;

FIG. 14A is an enlarged view of encircled area 14A in FIG. 14; and

FIG. 15 is a top plan view of portions of the apparatus and the casting drum of FIG. 14.

### PARTS LIST

A list of parts which may preferably be included in, and/or used in conjunction with, the invention and/or the prior art are as follows:
Casting Drum 20
Casting Drum Center of Rotation 22
Casting Drum Drive Shaft 24
Direction of Casting Drum Rotation “A”
Oil Bank 25
Gel/Gelatin/Ribbon 26
Ink 28
Printing Roller Apparatus 30
Printing Roller 40
Direction of Printing Roller Rotation “B”
Rubber Drive Ring 42
Casting Drum Drive Pulley 43
Printing Roller Drive Pulley 44
Drive Belt/Chain 46
Direction of Drive Belt/Chain “E”
Drive Gear 46′
Casting Drum Drive Gear 46A
Printing Roller Drive Gear 46B
Print Indicia 48
Scraper/Spreader Roller 50
Direction of Scraper/Spreader Roller Rotation “C”
Ink Roller 60
Direction of Ink Roller Rotation “D”
Ink Tray/Well 62
Ink/Dye Gear 64
Roller Plate 70
Pressure Adjustment Knob 72
Mounting Housing 74
Secondary Scraper 76
Transfer Roller 80
Transfer Roller Gear 82
Direction of Transfer Roller Rotation “F”
Bearings 90A, 90B, 90C
Suspension Guides 92A, 92B, 92C
Suspension Springs 94A, 94B, 94C

### DETAILED DESCRIPTION OF A PREFERRED EMBODIMENT

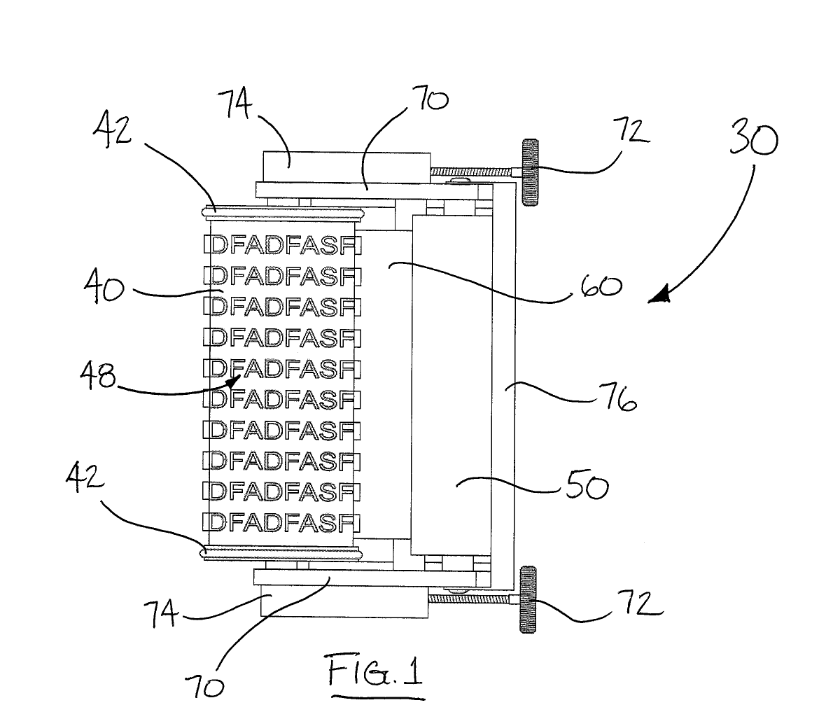

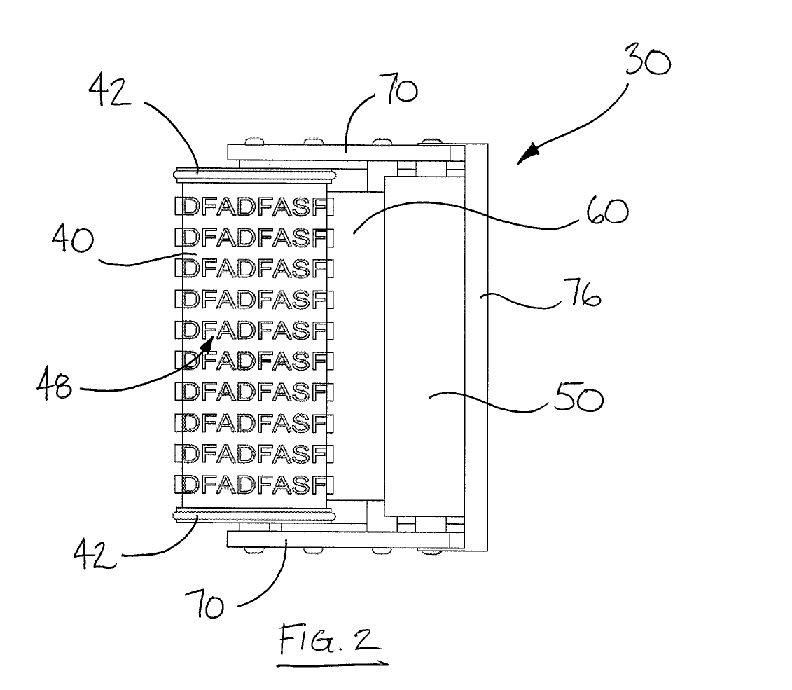

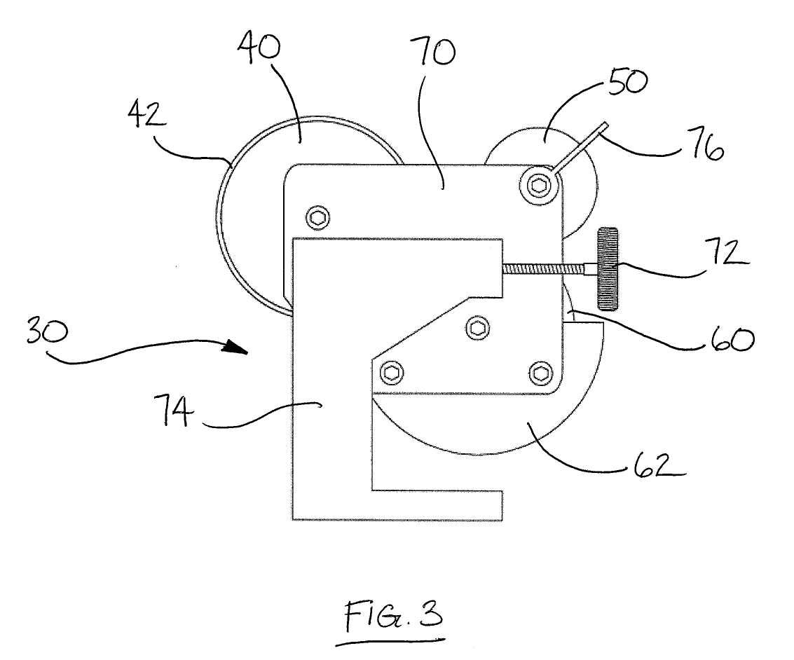

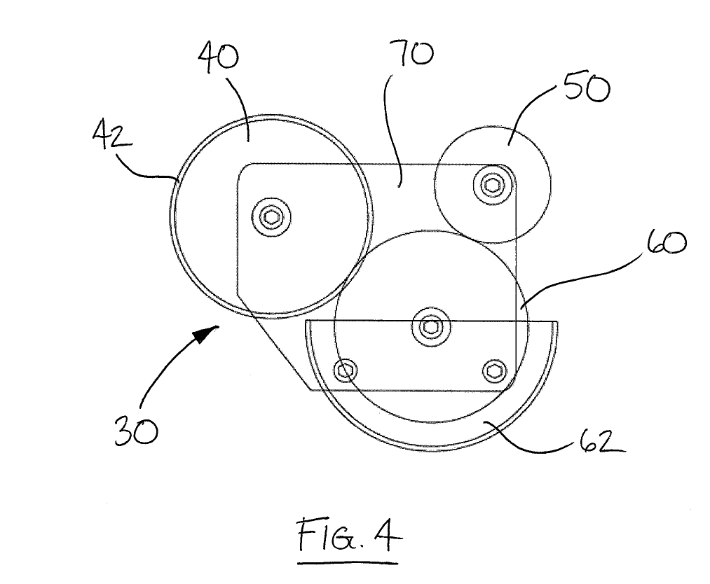

Referring now to FIGS. 1 through 6 of the drawings, there is shown a printing roller apparatus 30, for use with a casting drum 20, which is suitable to print indicia 48 onto a gel (not shown) on the casting drum 20. The casting drum 20 has a center of rotation (not shown), and the gel (e.g., gelatin) is carried thereon. The printing roller apparatus 30 includes, among other things, a printing roller 40, a rubber drive ring 42 (and/or a drive belt, chain and/or gears 46), a scraper/spreader roller 50, an ink roller 60, an ink tray 62, a pressure adjusting knob 72, and a secondary scraper 76.

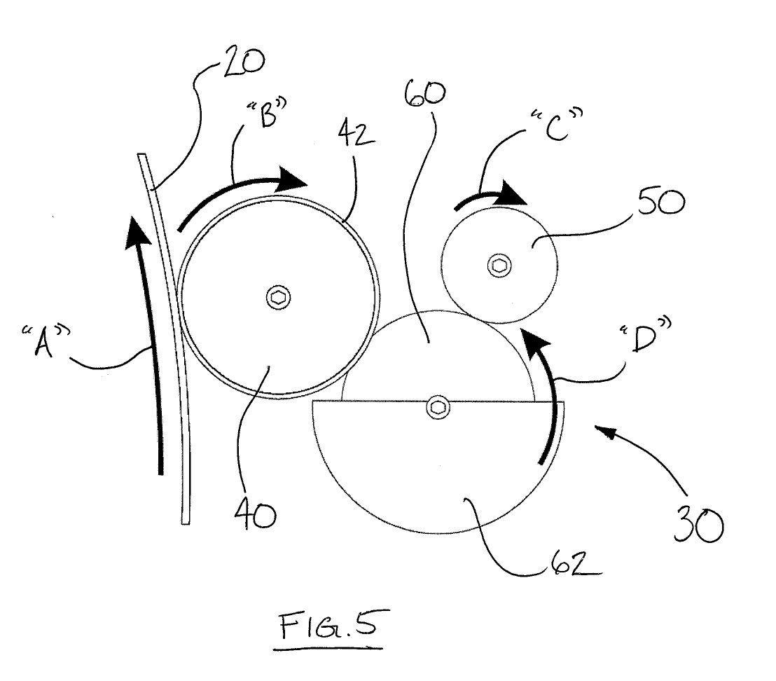

Preferably, and as best seen in FIG. 5, as the casting drum 20 and gel (not shown) move past the printing roller 40, pressure is applied on the rubber drive ring 42 by adjusting the pressure adjusting knob(s) 72—i.e., so as to cause contact of the rubber drive ring 42 with the casting drum 20. This contact (and/or the force of static friction) between the casting drum 20 and the rubber drive ring 42 on the printing roller 40 preferably causes the casting drum 20 to drive the printing roller 40 which, in turn, drives the rest of the assembly 30 (see FIG. 5).

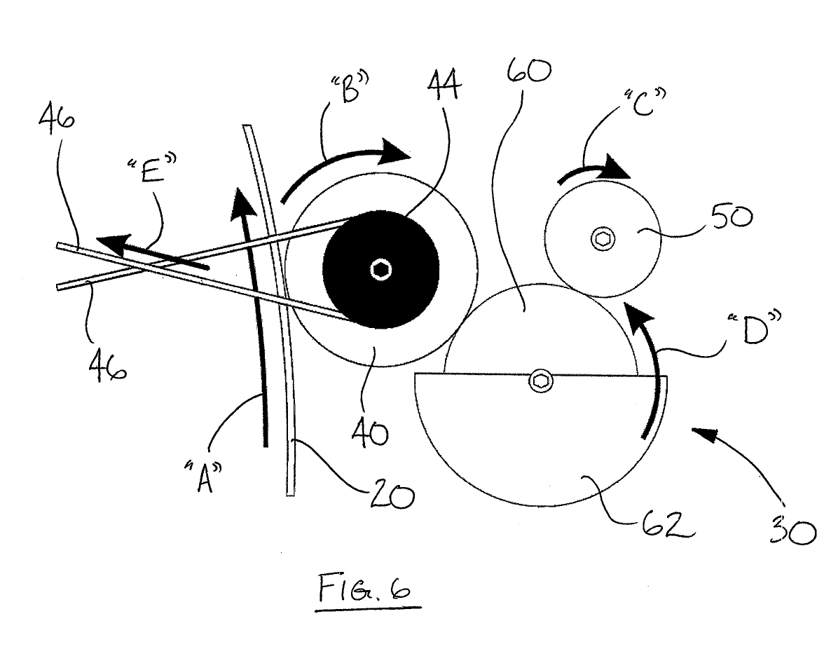

Alternately, and as best seen in FIG. 6, the assembly 30 may be driven by a drive belt/chain 46 (and/or gears). This alternate drive method may pick-up the rotation of the casting drum 20 from its center of rotation (not shown) at a 1:1 ratio (see FIG. 6). An arrangement of the general sort shown in FIG. 6 may result in the same speed of rotation as direct drive method(s).

Printing onto the ribbon occurs thereafter. Preferably, in order to print, further pressure must be applied to the rubber drive ring 42 (as it is preferably raised above the lettering/indicia 48 on the printing roller 40). This adjustment may preferably, but need not necessarily, allow for fine tuning of the printing quality and/or the ink transfer to the gelatin (not shown).

Preferably, as the printing roller 40 rotates, it picks up ink (not shown) by contact with the ink roller 60, and it transfers the ink to the gelatin (not shown). As the ink roller 60 rotates, it picks up ink (not shown) from the ink tray 62 that it is (partially) submerged in.

When the ink roller 60 rotates from the ink tray 62 towards the printing roller 40, it passes the scraper/spreader roller 50 and the secondary scraper 76. The scraper/spreader roller 50 preferably removes excess ink (not shown) from the ink roller 60, and it helps to ensure and/or to facilitate a substantially even distribution of ink (not shown) over the surface of the ink roller 60. The secondary scraper preferably helps to prevent and/or to reduce the chance of excess ink overflow (not shown).

Preferably, after the ink roller 60 passes the scraper/spreader roller 50, the uniform ink coating (not shown) on the ink roller 60 is transferred to the printing roller 40.

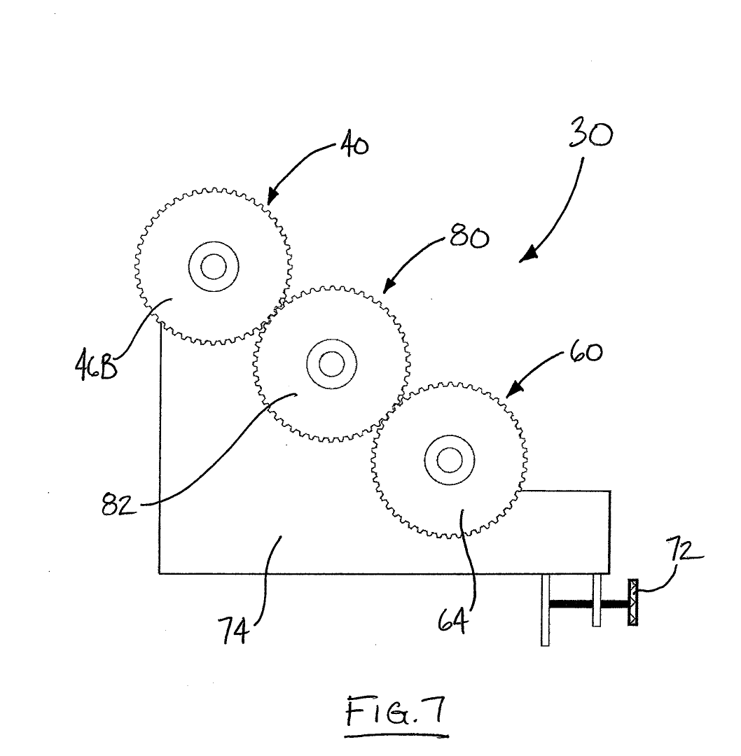

Referring now to FIGS. 7 through 15 of the drawings, there is shown a printing roller apparatus 30, for use with a casting drum 20, which is suitable to print indicia (e.g., lettering) 48 onto a gel 26 on the casting drum 20. The casting drum 20 has a center of rotation 22, and the gel (e.g., gelatin) 26 is carried thereon. The printing roller apparatus 30 preferably includes, among other things, a printing roller 40 provided with print indicia 48 (not shown in FIGS. 7 through 15), a rubber drive ring 42, an adjusting knob 72, suspension springs 94A,94B,94C, a transfer roller 80, an ink roller 60, and an ink well 62.

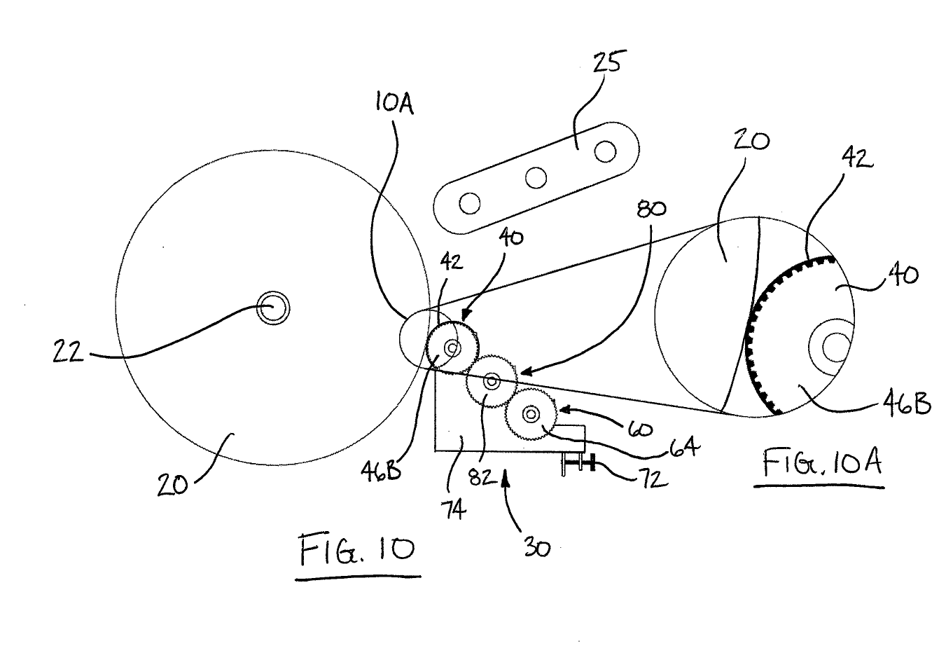

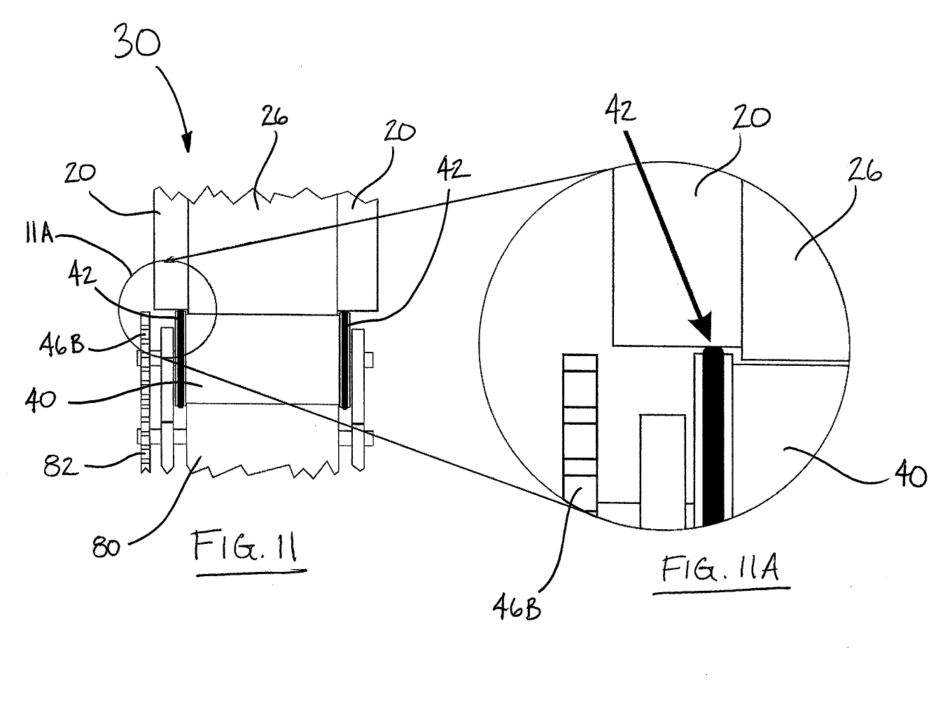

As the casting drum 20 and gel 26 move past the printing roller 40, pressure is preferably applied on the rubber drive ring 42 (see FIGS. 10, 11 and 11A) by tightening the adjusting knob 72, so as to cause contact with the casting drum 20. This contact (and/or the force of static friction) between the casting drum 20 and the rubber drive ring 42 preferably causes the casting drum 20 to drive the printing roller 40 which, in turn, preferably drives the rest of the assembly 30 (see FIG. 7).

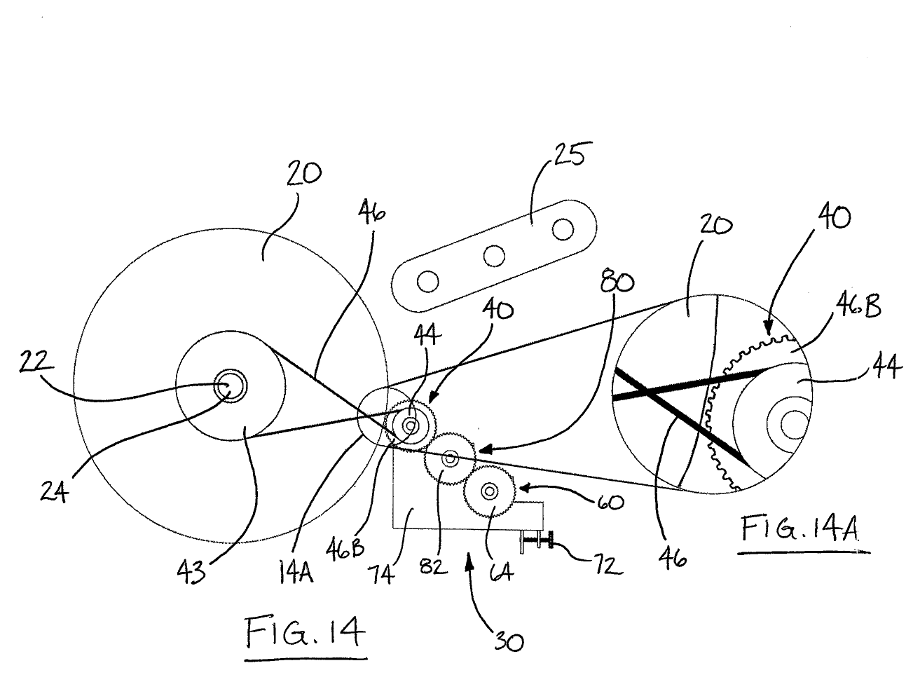

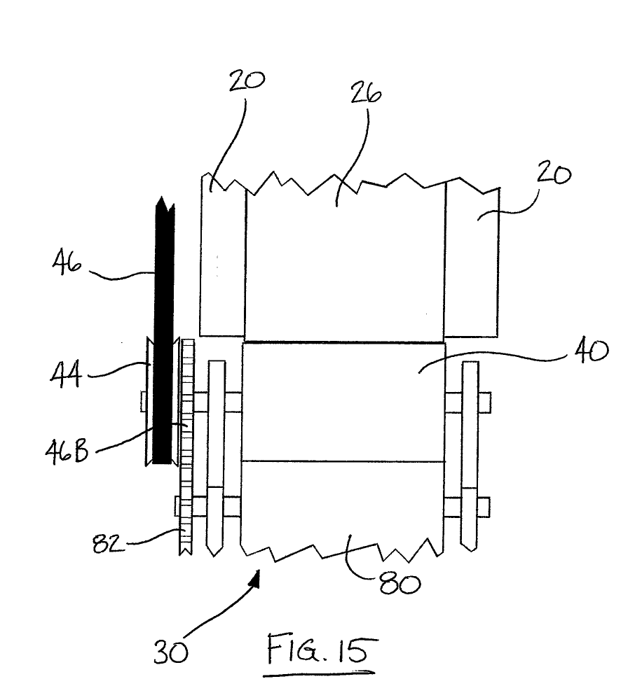

In the alternate embodiment of the invention which is shown in FIGS. 14, 14A and 15, the assembly 30 may alternately be driven by a drive belt or chain 46. This alternate drive method (see FIGS. 14, 14A and 15) preferably picks-up the rotation of the casting drum 20, from substantially adjacent to its center of rotation 22, using a set of pulleys 43,44 or a set of sprockets and chains (not shown).

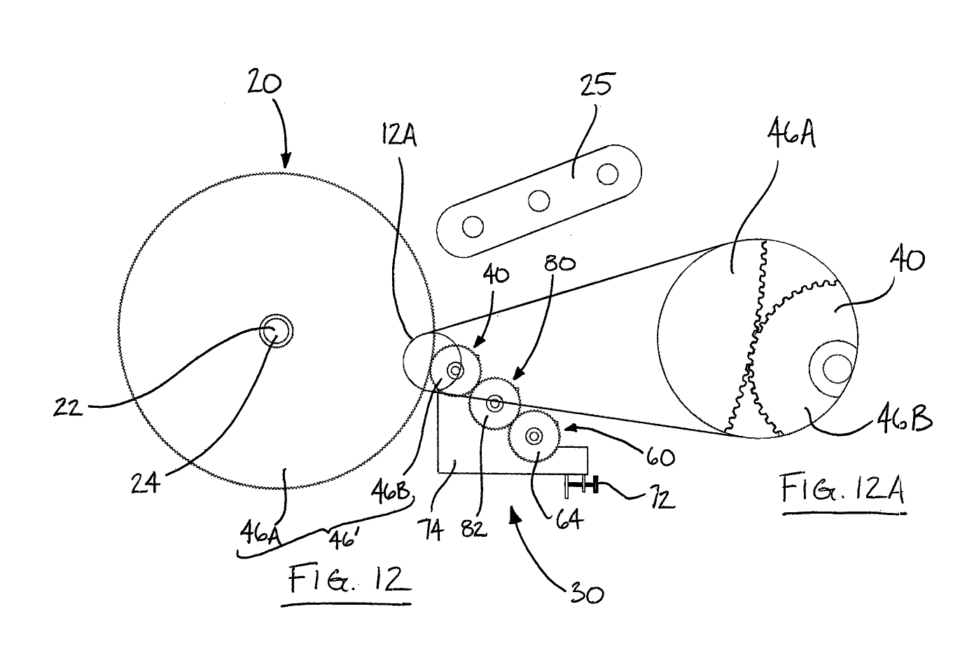

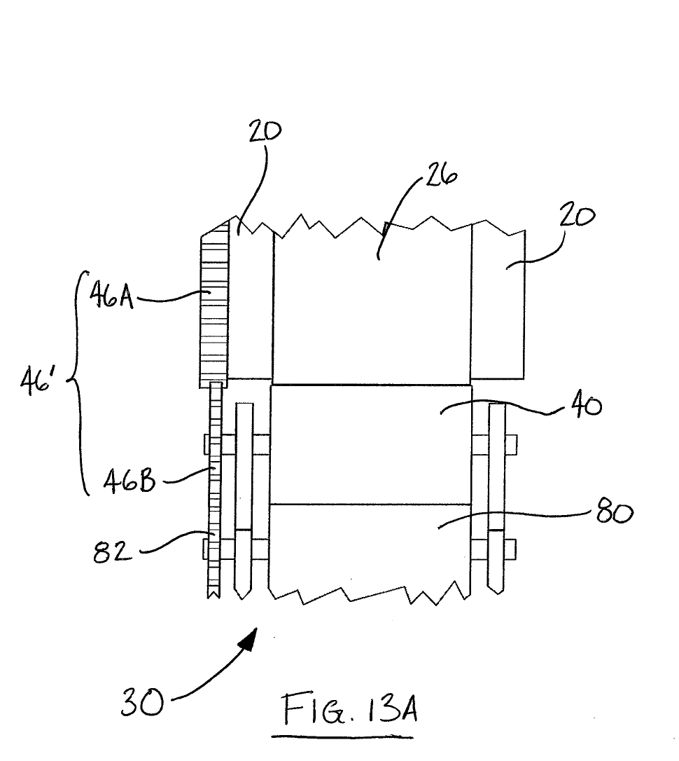

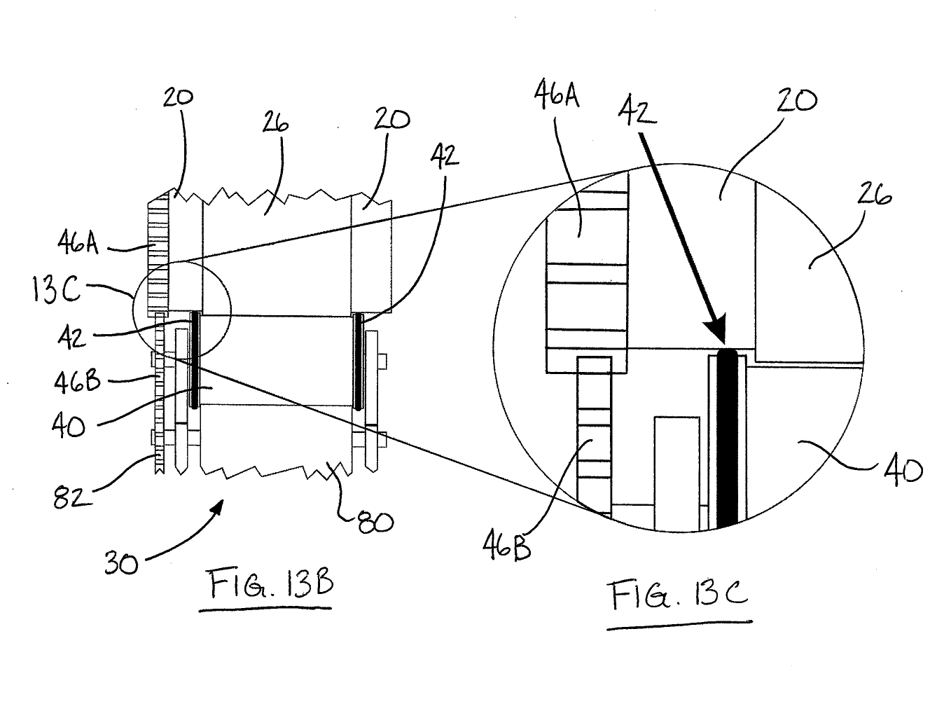

In the yet further alternate embodiment of the invention which is shown in FIGS. 12, 12A and 13A, the assembly 30 may alternately be driven by a drive gear 46′. This alternate drive method preferably picks-up the rotation of the casting drum 20, from substantially adjacent to its center of rotation 22, by affixing a large casting drum drive gear 46A to the drive shaft 24 of the casting drum 20 and having this gear 46A connect with the printing roller drive gear 46B (see FIGS. 12, 12A and 13).

In a still yet further alternate embodiment of the invention which is shown in FIGS. 13B and 13C, the assembly 30 may alternately be driven by both a drive gear 46′ and a rubber drive ring 42. In this alternate drive method pressure is preferably applied on the rubber drive ring 42 (see FIGS. 13B and 13C) by the adjusting knob 72, so as to cause contact with the casting drum 20. This contact (and/or the force of static friction) between the casting drum 20 and the rubber drive ring 42 is preferably part of what causes the casting drum 20 to drive the printing roller 40. Additionally, this alternate drive method picks-up the rotation of the casting drum 20, from substantially adjacent to its center of rotation 22, by affixing a large casting drum drive gear 46A to the drive shaft 24 of the casting drum 20 and having this gear 46A connect with the printing roller drive gear 46B (see FIGS. 12, 12A and 13).

In all of the three alternate embodiments of the invention described immediately above, an arrangement of this general sort preferably results in the same results and/or speed of rotation as direct drive method(s).

In the embodiment of the invention which is shown in FIGS. 10, 11 and 11A, printing onto the ribbon 26 preferably occurs by applying further pressure to the rubber drive ring 42, so as to allow it to collapse so that the printing roller 40 makes contact with the gelatin ribbon 26 (since the rubber drive ring 42 is preferably raised above the lettering 48 on the printing roller 40).

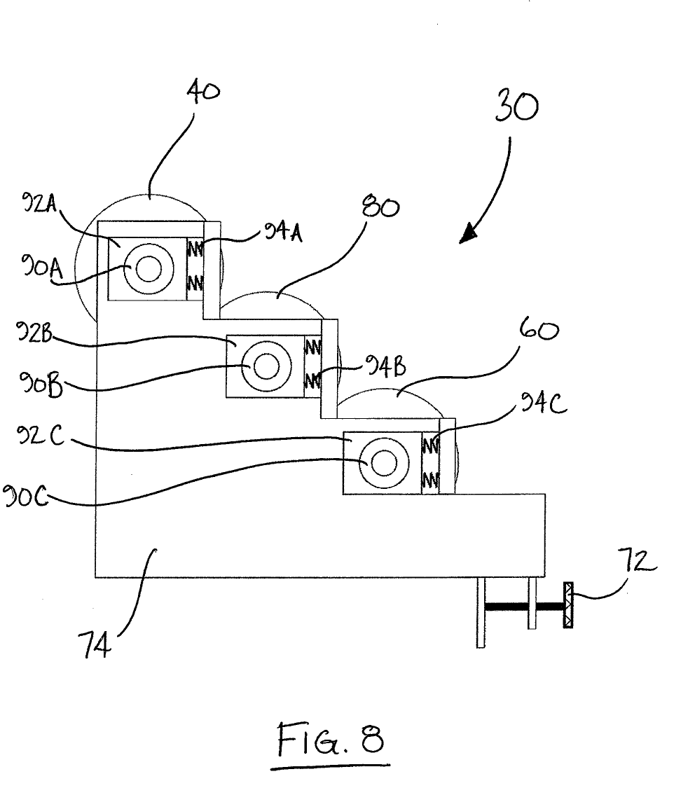

The suspension springs 94A,94B,94C (see FIG. 8) preferably allow for variations in gelatin ribbon 26 thickness, without requiring constant manual adjustment. Accordingly, the suspension springs 94A,94B,94C preferably allow for fine tuning of the printing quality and/or the ink transfer to the gelatin 26, without having to constantly monitor the printer 30.

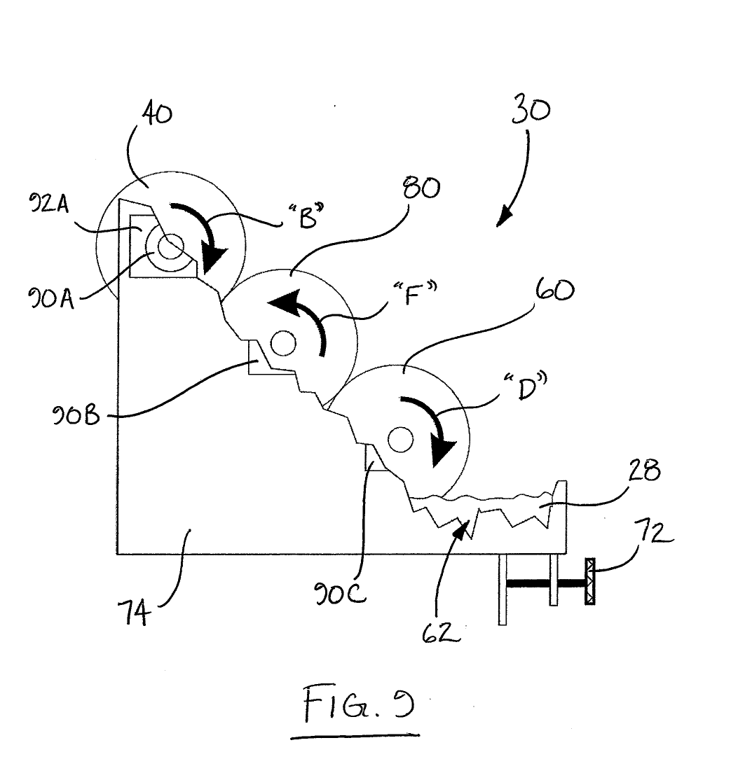

As the printing roller 40 rotates, it preferably picks up ink 28 by direct contact with the transfer roller 80 (see FIG. 9), and the printing roller 40 preferably transfers the ink 28 to the gelatin 26. The transfer roller 80 preferably allows for a small amount of ink 28 to be picked up from the ink roller 60. This feature of the transfer roller 80 preferably helps to ensure that the printing roller 40 will not—and/or to decrease the risk that the printing roller 40 will—(A) become saturated with ink 28, or (B) produce a faulty image or print.

As the transfer roller 80 rotates, it preferably collects ink 28 from the ink roller 60 by direct contact (see FIG. 9) therewith. The suspension springs 94A,94B,94C (see FIG. 8) preferably help to ensure, or to increase the likelihood, that constant contact is maintained between the rollers 40,80,60—preferably so as to create an even coverage of ink.

As the ink roller 60 rotates, it preferably collects ink 28 from the ink well 62 that it is provided in the bottom of the housing 74. The ink roller 60 is preferably partially submerged (see FIG. 9) in the ink 28—preferably so as to allow for substantially constant replenishment of ink 28 on the ink roller 60.

Persons having ordinary skill in the art will appreciate that the present invention obviates and/or mitigates one or more of the above-mentioned disadvantages of the prior art.

Other modifications and alterations may be used in the design and manufacture of other embodiments according to the present invention without departing from the spirit and scope of the invention, which is limited only by the accompanying claims of this application.

I claim:

1. A printing roller apparatus and method, for use with ink and a gel carried on an operatively rotating casting drum, the apparatus and method comprising:
a) a print roller having an exterior print surface operatively and rollably engaging the gel; and
b) a drive member directly engaging the casting drum and operatively rotating the print roller, such that the print surface moves coincident with the gel carried on the operatively rotating casting drum;
wherein a substantially even distribution of the ink is transferred from the print surface to the gel, so as to clearly print at least one print indicium thereon.

2. A printing roller apparatus and method for use with a gel carried on a casting drum having a center of rotation, said apparatus and method comprising:
a) a printing roller, rollably engaging the gel carried on the casting drum, with the printing roller being provided with:
i) print indicia on an exterior roller surface thereof; and
ii) A) two rubber drive rings, one each adjacent a respective end of the exterior roller surface of the printing roller (and raised above the print indicia), each rollably and directly engaging the casting drum; AND/OR
B) I) at least one drive pulley adjacent one end of the exterior roller surface of the printing roller, and
II) a drive belt/chain engaging the drive pulley and directly engaging the casting drum substantially adjacent its center of rotation; AND/OR
C) I) at least one printing roller drive gear adjacent one end of the exterior roller surface of the printing roller, and
II) at least one casting drum drive gear, adjacent one end of the casting drum, engaging the printing roller drive gear; AND/OR
b) a pressure adjusting knob, to adjust the coefficient of static friction between the rubber drive rings and the casting drum;
c) i) A) an ink roller rollably engaging the exterior roller surface of the printing roller; and
B) a scraper/spreader roller rollably engaging the ink roller; and
C) a secondary scraper scrape-ably engaging the scraper/spreader roller; OR
ii) A) a transfer roller rollably engaging the exterior roller surface of the printing roller; and
B) an ink roller rollably engaging the exterior roller surface of the transfer roller;
d) an ink tray containing a reservoir of ink, with the ink roller being partially submerged therein;
wherein as the casting drum and gel move past the printing roller, pressure is applied on the rubber drive ring by adjusting the pressure adjusting knobs, so as to cause contact of the rubber drive ring with the casting drum, and so as to cause the casting drum to drive the printing roller which, in turn, drives the rest of the assembly;
(and/or wherein, alternately, the assembly is driven by a drive belt/chain, or by a drive gear, that picks-up the rotation of the casting drum from its center of rotation, so as to result in the same speed of rotation as the direct drive method;)
wherein further pressure is applied (to the rubber drive ring) so as to enable printing onto the gelatin and/or to allow for fine tuning of the printing quality and/or the ink transfer to the gelatin;
wherein, as the printing roller rotates, it picks up ink by (direct) contact with the ink roller (or the transfer roller), and it transfers the ink to the gelatin;
(and/or wherein, as the transfer roller rotates, it picks up ink by (direct) contact with the ink roller;)
wherein, as the ink roller rotates, it picks up ink from the ink tray that it is partially submerged in;
(and/or wherein, as the transfer roller rotates from the ink roller towards the printing roller, only a small amount of ink is picked up from the ink roller;)
wherein, when the ink roller rotates from the ink tray towards the printing roller, it passes the scraper/spreader roller and the secondary scraper;
wherein, the scraper/spreader roller removes excess ink from the ink roller, and helps to ensure and/or to facilitate a substantially even distribution of ink over the surface of the ink roller; and
wherein the secondary scraper helps to prevent and/or to reduce the chance of excess ink overflow.
